(19) United States
(12) Patent Application Publication
(10) Pub. No.: US 2014/0111306 A1
(43) Pub. Date: Apr. 24, 2014

(54) LOCKING MECHANISM AND LOCKING SYSTEM

(71) Applicants: Tsutomu Kawase, Tokyo (JP); Yoshiaki Nishizaki, Tokyo (JP); Takahisa Yamaguchi, Tokyo (JP); Yukiko Yamazaki, Tokyo (JP)

(72) Inventors: Tsutomu Kawase, Tokyo (JP); Yoshiaki Nishizaki, Tokyo (JP); Takahisa Yamaguchi, Tokyo (JP); Yukiko Yamazaki, Tokyo (JP)

(73) Assignee: RICOH COMPANY, LTD., Tokyo (JP)

(21) Appl. No.: 14/056,171

(22) Filed: Oct. 17, 2013

(30) Foreign Application Priority Data
Oct. 18, 2012 (JP) 2012-231157

(51) Int. Cl. G07C 9/00

(52) U.S. Cl. CPC G07C 9/00896; G07C 9/00174
USPC 340/5.61

(57) ABSTRACT

A locking mechanism, that is attached to a device acquiring power from a power generator mounted on the device, includes a radio tag acquiring key information, which is for releasing locking, by radio communications; a short-circuit unit short-circuiting the power generator; and a control unit acquiring specific information of the device, making comparison between the specific information and the key information acquired by the radio tag, and causing the short-circuit unit to short-circuit the power generator based on a result of the comparison, so as to control locking of the device.

### CROSS-REFERENCE TO RELATED APPLICATIONS

The present application is based on claims the benefit priority under 35 U.S.C. §119 to Japanese Patent Application No. 2012-231157 filed on Oct. 18, 2012, the entire contents of which are hereby incorporated herein by reference.

### BACKGROUND OF THE INVENTION

1. Field of the Invention

The present invention relates to a locking mechanism and a locking system.

2. Description of the Related Art

Research and development has been made to provide a locking system for preventing bicycle theft (see, for example, Japanese Laid-open Patent Publication No. 11-134563). This Patent Document discloses a technique in which an open circuit is formed between an electric generator and a buzzer control circuit. According to this technique, even when a key locking part of a bicycle is broken by a person who attempts to steal the bicycle, the open circuit formed between the electric generator and the buzzer control circuit is maintained. Due to the remaining open circuit, when the bicycle detects the running mode by a speed detection circuit of the bicycle, the buzzer control circuit is activated to sound the buzzer.

### SUMMARY OF THE INVENTION

According to an aspect of the present invention, a locking mechanism, that is attached to a device acquiring power from a power generator mounted on the device, includes a radio tag acquiring key information, which is for releasing locking, by radio communications; a short-circuit unit short-circuiting the power generator; and a control unit acquiring specific information of the device, making comparison between the specific information and the key information acquired by the radio tag, and causing the short-circuit unit to short-circuit the power generator based on a result of the comparison, so as to control locking of the device.

### BRIEF DESCRIPTION OF THE DRAWINGS

Other objects, features, and advantages of the present invention will become more apparent from the following description when read in conjunction with the accompanying drawings, in which:

FIG. 1 shows an example overall configuration of a locking system according to an embodiment;

FIG. 2 shows an example light lighting circuit according to an embodiment;

FIG. 3 shows an example locking circuit using the light lighting circuit according to an embodiment;

FIG. 4 is an example flowchart of a locking/illumination control process according to an embodiment;

FIG. 5 is an example graph showing a locking function according to an embodiment;

FIG. 6 shows another example of a locking circuit using the light lighting circuit according to an embodiment;

FIG. 7 shows still another example of a locking circuit using the light lighting circuit according to an embodiment;

FIG. 8 is an example flowchart of a bicycle locking process according to an embodiment;

FIG. 9 is an example flowchart of a registration process of lock releasing information according to an embodiment;

FIG. 10 is an example flowchart of a lock release determination process according to an embodiment;

FIG. 11 is another example flowchart of the lock release determination process according to an embodiment; and

FIG. 12 shows example information items stored in the locking system according to an embodiment.

### DETAILED DESCRIPTION OF THE PREFERRED EMBODIMENTS

In the related-art technologies, a bicycle locking systems has been provided as disclosed in Japanese Laid-open Patent Publication No. 11-134563. However, in the locking system of Japanese Laid-open Patent Publication No. 11-134563, the key locking part is formed on a mechanical basis.

Therefore, even if the risk (frequency) of the bicycle theft is reduced by using the buzzer, it is not possible to effectively prevent the damage to the mechanically-formed locking part when the bicycle is stolen.

The present invention is provided in the light of the above problem, and may provide a locking mechanism and a locking system for locking a device that acquires power from an electronic (power) generator (hereinafter may be simplified as “generator”) by short-circuiting the generator.

In the following, preferred embodiments are described with reference to the accompanying drawings. In the description and figures, the same reference numerals may be repeatedly used to describe the elements having substantially the same function or configuration, and the repeated descriptions thereof may be omitted.

### Overall System Configuration

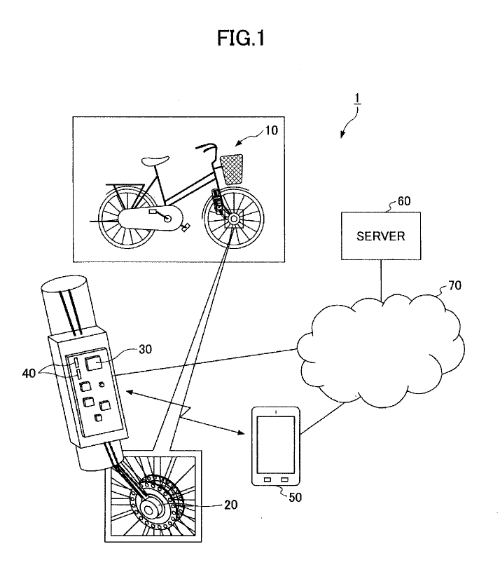

First, an example overall configuration of a locking system according to an embodiment is described with reference to FIG. 1. FIG. 1 shows an example overall configuration of a locking system according to this embodiment.

As shown in FIG. 1, a locking system 1 includes a light lighting circuit 30 including a locking control circuit and a passive Radio Frequency Identification (RFID) tag 40 (hereinafter simplified as “RFID tag 40”), the light lighting circuit 30 being connected to a generator 20 mounted (installed) on a bicycle 10. It should be noted that, for example, the light lighting circuit 30 and the RFID tag 40 may be integrated into the generator 20.

The RFID tag 40 transmits and receives information to and from a mobile phone 50 by using a reader/writer function of the mobile phone 50. The RFID tag 40 is operated on the principle of an electromagnetic induction phenomenon or the like at a close range from about one meter to about two meters from the antenna of the mobile phone 50 to transmit and receive radio waves to and from the mobile phone 50.

Here, it should be noted that the RFID tag 40 is an example of a radio tag that externally acquires key information to release locking based on radio communications. More specifically, for example, a UHF-band RFID tag or an HF-band FEID tag (with a Near Field Communication (NFC) reader) or the like may be used to realize (the function of) the REID tag 40.

Further, besides the mobile phone 50 according to an embodiment, as an apparatus that externally transmits key information to the radio tag via wireless communications, any one of electronic devices having the reader/writer function including a smartphone, a mobile information terminal, and a game apparatus may be used.

In the locking system 1 according to this embodiment, as a locking mechanism installed in the apparatus that acquires power from the generator 20, a locking mechanism using the generator 20 attached to the bicycle 1 is exemplarily described.

The mobile phone 50 is wirelessly connected to a server 60 via a network 70.

A user of the bicycle 1 performs user registration (i.e., registers user ID) to register bicycle specific information as key information to release locking of the bicycle 10 in the server 60 using the mobile phone 50. As the bicycle specific information, for example, the user may set user's personal identification number (PIN) using the mobile phone 50.

Otherwise, for example, the user may generate a random number using a random-number generator and write the generated random number in the server 60 as temporary key information when the key of the bicycle 10 is locked. When the key information is updated every time, the security is accordingly enhanced.

Further, when there is master information related to the bicycle specific information, it is possible to reset the key information (i.e., bicycle specific information) based on the master information. The master information is stored only in the server 60, and only when the server 60 is connected to the mobile phone 50, the bicycle specific information is reset based on the master information.

In this case, the server manages information items indicating where and whose mobile phone 50 is connected to the server 60 based on the right of whose user ID and that the bicycle specific information of which bicycle 10 is reset. The bicycle specific information is compared (verified) with the key information input via the mobile phone 50 when the user releases the lock of the bicycle 10.

The bicycle specific information other than the master information is not necessarily stored in the server 60, and may be stored in the REID tag 40 or a (Central Processing Unit) CPU 307 described below.

### Light Lighting Circuit

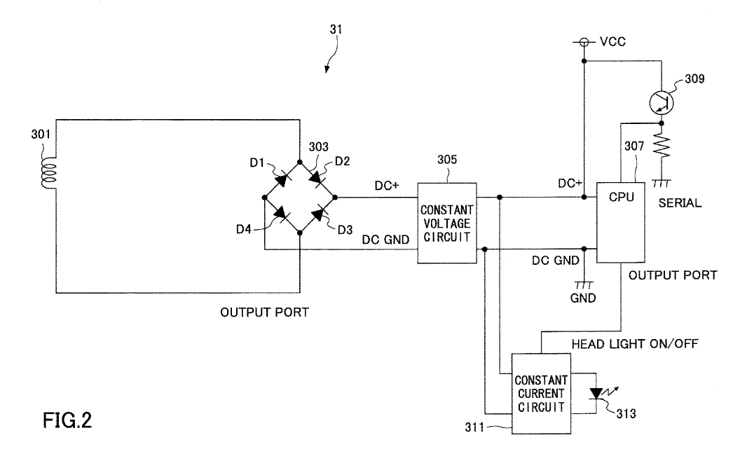

Next, a light lighting circuit is described with reference to FIG. 2. FIG. 2 shows an example light lighting circuit. A light lighting circuit 31 of FIG. 2 does not have a function of the locking control circuit. The light lighting circuit 31 turns on the light when the pedals of the bicycle 10 are driven so that the generator generates power.

As shown in FIG. 2, the light lighting circuit 31 includes a dynamo coil 301, a rectifier circuit 303, a constant voltage circuit 305, the CPU 307 (or an illuminance detection circuit), an illuminance confirming photoelectric device 309, a constant current circuit 311, and a light-emitting diode 313.

The dynamo coil 301 is an example of the generator. A detail configuration of the dynamo coil 301 is not shown. However, in brief, the dynamo coil 301 includes an axle passing through the center and a hub (wheel case) provided on the outer periphery side of the axle. Coils and an iron core are fixed to the axle. Further, a plurality of permanent magnets is adhered to the inner wall of the hub. When the tire of the bicycle 10 is rotated, the magnetic flux passing through the coil changes.

Then, due to the electromagnetic induction phenomenon, an induced electromotive force is generated at the coil of the generator, a current flows, and power is generated. The dynamo coil 301 is an example of the generator that generates power in accordance with the rotation of the tire or the pedals of the bicycle 10. However, the generator is not limited to the dynamo coil. For example, the generator may be a Direct Current (DC) generator or an Alternating Current (AC) generator.

The input side and the output side of the dynamo coil 301 are connected to the rectifier circuit 303. The rectifier circuit 303 is a bridge type full-wave rectifier including four diodes D, D2, D3, and D4 to convert alternating voltage generated by the dynamo coil 301 into current voltage.

The constant voltage circuit 305 is connected between the output line on the power side (DC+) of the rectifier circuit 303 and the output line on the ground side (DC GND) of the rectifier circuit 303. Here, the output line on the power side (DC+) is a power line, and the output line on the ground side (DC GND) is a ground line which is grounded.

The direct voltage output from the rectifier circuit 303 continually fluctuates. To resolve this problem, the constant voltage circuit 305 includes a capacitor or constant voltage diode, so that the ripple component of the current output from the rectifier circuit 303 is removed to obtain stabilized voltage. For example, when a certain amount of charge is stored in the capacitor of the constant voltage circuit 305, a current flows to the CPU 307 side. By doing this, a voltage greater than or equal to a certain value is supplied to the CPU 307.

The CPU 307 is connected between the output line on the power side (DC+) of the constant voltage circuit 305 and the output line on the ground side (DC GND) of the constant voltage circuit 305. Further, the constant current circuit 311 is also connected between the output line on the power side (DC+) of the constant voltage circuit 305 and the output line on the ground side (DC GND) of the constant voltage circuit 305.

The operation of the CPU 307 is started (switch on) based on the voltage supplied from the constant voltage circuit 305 when the certain amount of charge is stored in the capacitor of the constant voltage circuit 305, and the operation of the CPU 307 is stopped (switch off) when the voltage supplied from the constant voltage circuit 305 is zero.

The illuminance confirming photoelectric device 309 is a device, connected to the power line, that converts an amount of sun light into a voltage value. The CPU 307 determines whether, for example, the light-emitting diode 313 is to be switched on based on the fluctuation of the voltage value from the illuminance confirming photoelectric device 309.

More specifically, when the voltage value supplied from the illuminance confirming photoelectric device 309 is greater than a certain lighting standard value, the CPU 307 determines that it is not necessary to irradiate light by the light-emitting diode 313 and switches off an illumination switch of the CPU 307 the light-emitting diode 313).

On the other hand, when the voltage value supplied from the illuminance confirming photoelectric device 309 is less than or equal to the certain lighting standard value, the CPU 307 determines that it is necessary to irradiate light by the light-emitting diode 313 and switches on the illumination switch of the CPU 307 (the light-emitting diode 313). Based on the switch on and off operation of the CPU 307, the light-emitting diode 313 is turned on and off, respectively.

The constant current circuit 311 functions as a protection circuit to prevent an overcurrent from flowing through the light-emitting diode 313. The constant current circuit 311 and the constant voltage circuit 305 are arranged in parallel between the rectifier circuit 303 and the CPU 307 and are an example of a stabilizing circuit that stabilizes the voltage output from the rectifier circuit 303.

Next, the operations of the light lighting circuit 31 are briefly described. When a user operates (rotates) the pedals of the bicycle 10, the permanent magnets in the dynamo coil 301 rotate in accordance with the rotation of the tire of the bicycle 10. Due to the axle side being fixed, the magnet flux passing through the coil changes by the rotation of the tire.

Then, due to the electromagnetic induction phenomenon, an induced electromotive force is generated at the coil of the generator. By doing this, the dynamo coil 301 generates power. The current flows in the power line in the direction of rectifier circuit 303→constant voltage circuit 305→CPU 307. When the illumination switch of the CPU 307 is turned on, a current flows to the light-emitting diode 313 to turn on the light-emitting diode 313.

### Light Lighting Circuit Including Locking Control Circuit

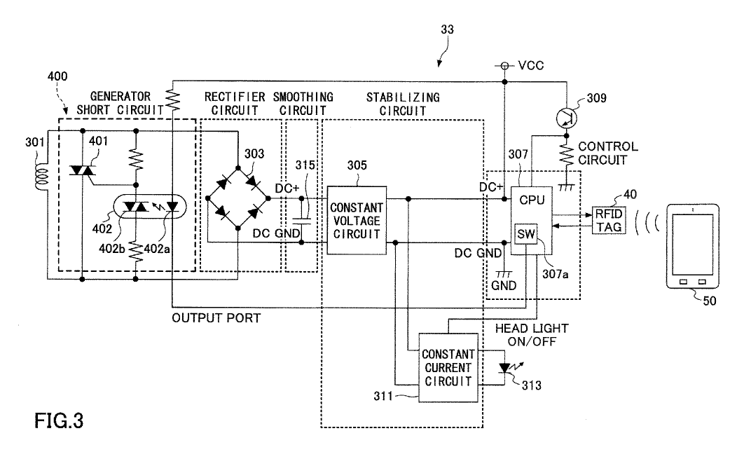

Next, a light lighting circuit including a locking mechanism according to an embodiment is described with reference to FIG. 3. FIG. 3 shows an example light lighting circuit having a locking mechanism according to an embodiment. Basically, a light lighting circuit 33 including a locking mechanism is similar to the light lighting circuit 31 as shown in FIG. 2 but further includes the locking mechanism for locking in a predetermined case.

Similar to the light lighting circuit 31 in FIG. 2, the light lighting circuit 33 including the locking mechanism includes the dynamo coil 301, the rectifier circuit 303, the constant voltage circuit 305, the CPU 307, the illuminance confirming photoelectric device 309, the constant current circuit 311, and the light-emitting diode 313.

The light lighting circuit 33 including the locking mechanism further includes a generator short circuit 400 (that short-circuits the generator (dynamo coil 301)) and a smoothing (flattening) circuit 315.

In the light lighting circuit 33, the light-emitting diode 313 is turned on by a voltage that is supplied from the dynamo coil 301 via the rectifier circuit 303 and the constant voltage circuit 305. The generator short circuit 400 is provided (connected) between the dynamo coil 301 and the rectifier circuit 303. The smoothing circuit 315 is provided (connected) between the rectifier circuit 303 and the constant voltage circuit 305.

The generator short circuit 400 according to this embodiment includes a triac 401 and a photo coupler 402. The photo coupler 402 converts an input (received) electric signal into an optical signal and transmits a signal through a light receiving device (of the photo coupler 402) based on the converted optical signal.

Namely, the photo coupler 402 includes a light-emitting diode 402a as the input circuit and a photo triac 402b as the output circuit. As the output circuit, instead of using the photo triac 402b, for example, a photo transistor, a photo diode, or a thyristor may be used.

In the generator short circuit 400, when the light-emitting diode 402a as the input circuit is conducting and emits light, the photo triac 402b receives the light and supply a trigger voltage to the gate of the triac 401 that is provided for controlling the short-circuit of the dynamo coil 301.

When the trigger voltage is applied to the gate of the triac 401 and the current flows, the triac 401 is set to be in a conducting state. By doing this, it becomes possible to form a short-circuit between the input side and the output side of the dynamo coil 301.

When the dynamo coil 301 is short-circuited as described above, the power from the dynamo coil 301 cannot be supplied to the rectifier circuit 303 side. As a result, the light lighting circuit 33 cannot operate, and the bicycle 10 is locked. The generator short circuit 400 is an example of a short-circuit unit that can short-circuit the dynamo coil 301.

The smoothing circuit 315 is a capacitor connected in parallel between the rectifier circuit 303 and the constant voltage circuit 305 (FIG. 3). The waveform of the DC voltage after rectification by the rectifier circuit 303 is rippling. Therefore, to flatten the waveform of the DC voltage, the capacitor of the smoothing circuit 315 is used to store electric charge.

### Locking Operation

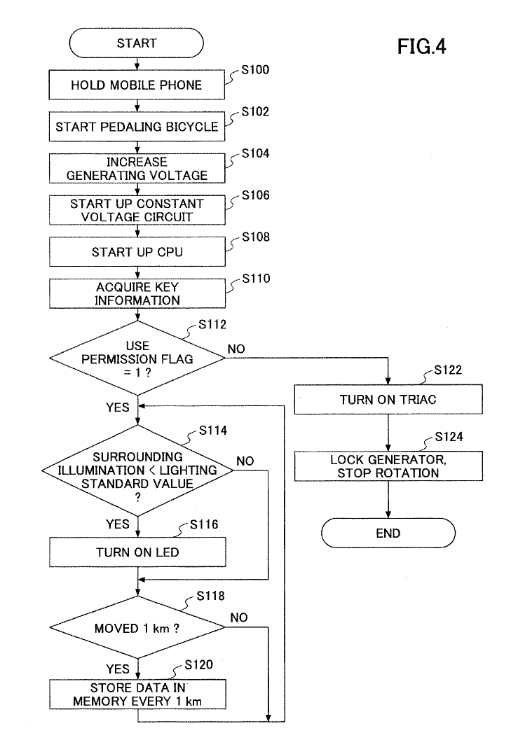

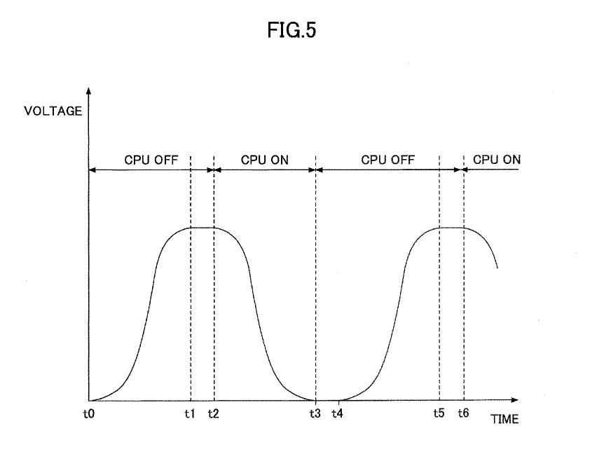

Next, the operations of the light lighting circuit 33 including a locking mechanism are described with reference to FIGS. 4 and 5. FIG. 4 is an example flowchart of a locking/illumination control process according to an embodiment. FIG. 5 is an example graph showing a locking function according to an embodiment based on voltage and time (as the bicycle 10 moves).

When a user wishes to use the bicycle 10, the user needs to release the locking of the bicycle 10. In this case, the user holds the mobile phone 50 over the hub (RFID tag 40) of the bicycle 10 (step S100).

By doing this, the RFID tag 40 receives “input key information” from the mobile phone 50 using wireless communications such as infrared communications. The “input key information” herein refers to key information to be input (used) to release the locking of the bicycle 10.

The CPU 307 (corresponding to a control unit) acquires (or may store in advance) the bicycle specific information of the bicycle 10 from the RFID tag 40. Then, the CPU 307 compares the bicycle specific information with the input key information acquired from the RFID tag 40.

Based on the comparison result, the CPU 307 causes the generator short circuit 400 to be in a conducting state to short-circuit the dynamo coil 301 to lock the bicycle 10. To that end, the CPU 307 sets a value in a “use permission flag”.

Specifically, when determining that the bicycle specific information corresponds to (is the same as) the input key information, the CPU 307 sets (holds) a value “1” (indicating that the comparison result is “OK”) in the use permission flag.

On the other hand, when determining that the bicycle specific information does not corresponds to is different from) the input key information, the CPU 307 sets (holds) a default value other than “1” (e.g., “0”) in the use permission flag.

After holding the mobile phone 50 over RFID tag 40 of the bicycle 10, when the user peddles the bicycle 10 (step S102), an induced electromotive force in accordance with the rotation of the tire is generated at the dynamo coil 301 and the generating voltage from the dynamo coil 301 increases (step S104).

When the generating voltage is greater than or equal to a predetermined voltage value, the constant voltage circuit 305 is started up (step S106). After that, when the capacitor of the constant voltage circuit 305 is fully charged, a predetermined voltage is supplied to the CPU 307, so that the CPU 307 starts operating (step S108). Next, the CPU 307 acquires the key information from the RFID tag 40 (step S110).

In this case, when the CPU 307 does not store the bicycle specific information of the bicycle 10 which is a comparison source, the CPU 307 further acquires the bicycle specific information from the REID tag 40.

With reference to FIG. 5, the relationships between the voltage value and a bicycle moving state in the locking mechanism according to an embodiment are described. In the graph of FIG. 5, the horizontal axis denotes time and the vertical axis denotes the voltage.

At time “t0”, the user starts peddling the bicycle 10. In response, during the period from time “t0” to time “t1”, the dynamo coil 301 generates power and the generating voltage increases, and a current flows through the power line. At time “t1”, the accumulation of charges starts in the capacitor of the constant voltage circuit 305.

At time “t2” when the amount of charges in the capacitor of the constant voltage circuit 305 is greater than or equal to a predetermined amount, a voltage is applied to the CPU 307 to set the CPU 307 to an operating state (CPU ON).

Referring back to FIG. 4, in step S112, the CPU 307 determines whether the value in the use permission flag is “1”. When determining that the value in the use permission flag is “1” (comparison result: OK), the bicycle specific information corresponds to (is the same as) the input key information.

Therefore, it is not necessary to lock the bicycle 10. In this case, a switch 307a of the CPU 307 is switched off and no current flows through the signal line (“output port”). Therefore, the photo triac 402b is set off (turned off) and the dynamo coil 301 does not short-circuit. Accordingly, it is possible to move the bicycle 10.

Further, in this case, the CPU 307 determines whether the surrounding illumination (i.e., sun-light illumination) is less than a lighting standard value (step S114). When determining that the surrounding illumination is less than the lighting standard value, the CPU 307 controls the lighting of the light-emitting diode 313 (step S116).

On the other hand, when determining that the surrounding illumination is greater than or equal to the lighting standard value, it is not necessary for the CPU 307 to cause the light-emitting diode 313 to emit light. Therefore, the process directly goes to step S118.

Next, the CPU 307 determines whether the bicycle 10 moved one kilometer (step S118), and stores the moved distance in a memory (step S120). Then, the process goes back to stop S114.

On the other hand, in step S112, when it is determined that the value in the use permission flag is other than “1” (comparison result: NG), the bicycle specific information does not correspond to (is different from) the input key information. Therefore, it is necessary to lock the bicycle 10. To that end, the process goes to step S122 to set the triac 901 to be in a conducting state.

Namely, the CPU 307 switches on (turns on) the switch 307a including a transistor to flow current through the signal line (“output port”) to turn on the light-emitting diode 402a of the photo coupler 402. By doing this, the photo triac 402b is set to be in a conducting state and the trigger voltage is applied to the gate of the triac 401.

As a result, the triac 401 is set to be in a conducting state (step S122), and a current flows through both the power line side and the signal line side of the triac 401. By doing this, when the triac 401 is set to be in a conducting state, the bicycle 10 is set to be in a locking state where no current flows through the power line even when the user pedals the bicycle 10, so that it is not possible to move the bicycle 10 (step S124).

As described above, the driving voltage that drives the generator short circuit 400 is supplied by the power generated by the dynamo coil 301. Further, when the bicycle specific information does not correspond to (is different from) the input key information, the CPU 307 outputs an ON signal from the switch 307a.

Due to the ON signal (i.e., a signal indicating “switch ON”), the triac 401 is set to be in a conducting state and accordingly, the dynamo coil 301 is set to be in a short-circuit state. As a result, the dynamo coil 301 cannot function as the power generator, the voltage supplied to the CPU 307 decreases from time “t2” in FIG. 5, and is “0” at time “t3”, so that the operation of the CPU 307 is turned off.

When the operation of the CPU 307 is stopped, the switch 307a of the CPU 307a is also turned off, so that an OFF signal (i.e., a signal indicating “switch OFF”) is transmitted to the light-emitting diode 402a. Due to the OFF signal, the light-emitting diode 402a stops emitting light, and the photo triac 402b is electrically separated.

As a result, the triac 401 is also electrically separated, and the short-circuit state of the dynamo coil 301 is released, so that the dynamo coil 301 is returned to be in a normal state. After that, when the user pedals the bicycle 10, the dynamo coil 301 starts generating power again, and the generating voltage increases. At time “t4” of FIG. 5, the state of the dynamo coil 301 is changed from the short-circuit state to the normal state, so that the generating voltage starts increasing at the time “t4”.

At time “t5”, the generating voltage is greater than or equal to the predetermined voltage value again, and the accumulation of charges starts in the capacitor of the constant voltage circuit 305. At time “t6” when the amount of charges in the capacitor of the constant voltage circuit 305 is greater than or equal to the predetermined amount, the voltage is applied to the CPU 307 again to set the CPU 307 to the operating state (CPU ON). At this point, when determining that the bicycle specific information does not correspond to (is different from) the input key information, the CPU 307 outputs the ON signal from the switch 307a again.

Due to the ON signal, the triac 401 is set to be in the conducting state and accordingly, the dynamo coil 301 is set to be in the short-circuit state. As a result, the dynamo coil 301 cannot function as the power generator, and the voltage supplied to the CPU 307 decreases from time “t6” in FIG. 5 again, so that the operation of the CPU 307 is turned off.

The above operation is repeated. Namely, the operations of the locking mechanism according to an embodiment are described where when a user attempts to pedal the bicycle 10, the bicycle 10 is locked; when the bicycle 10 is stopped, the locking released; and when the user attempts to pedal the bicycle 10, the bicycle 10 is locked again.

As described above, according to the locking/illumination control process in the embodiment, the locking mechanism includes at least the short-circuit unit capable of setting the generator to be in a short-circuit state and the control unit controlling the short-circuit unit so as to set the generator to be in a short-circuit state when authentication using the externally-acquired key information is failed.

By having such configuration, when the authentication based on the key information has failed, it is possible to lock the bicycle 10 by setting the dynamo coil 301 to be in a short-circuit state.

Namely, it is possible to provide a battery-less locking mechanism. Further, the locking mechanism according to an embodiment is provided as an inner circuit. Therefore, it is not easy to remove (separate) the locking mechanism. Therefore, it becomes possible to provide a locking mechanism having higher security.

Further, the following steps are sequentially repeated: user pedals the bicycle 10→the dynamo coil 301 rotates and the generating voltage increases→the CPU 307 start operating if the key authentication fails, the switch 307a of the CPU 307 is switch on→the dynamo coil 301 is set to be in the short-circuit state and power generation is stopped→the generating voltage decreases the operations of the CPU 307 stops→the switch 307a of the CPU 307 is switched off→the short-circuit state of the dynamo coil 301 is released and the power generation resumes.

As a result, even as a user pedals the bicycle 10, while the dynamo coil 301 is in the short-circuit state, the state where the bicycle 10 is to be stopped is repeated. Therefore, it becomes difficult to use (move) the bicycle 10. As described above, when the locking mechanism according to an embodiment is used, the bicycle 10 is electrically locked.

Further, due to the configuration where the short-circuit unit is added to the light lighting circuit 33 and the power generator which are generally mounted on a bicycle, this mechanism (system) may be easily integrated at low cost.

### First Modified Example

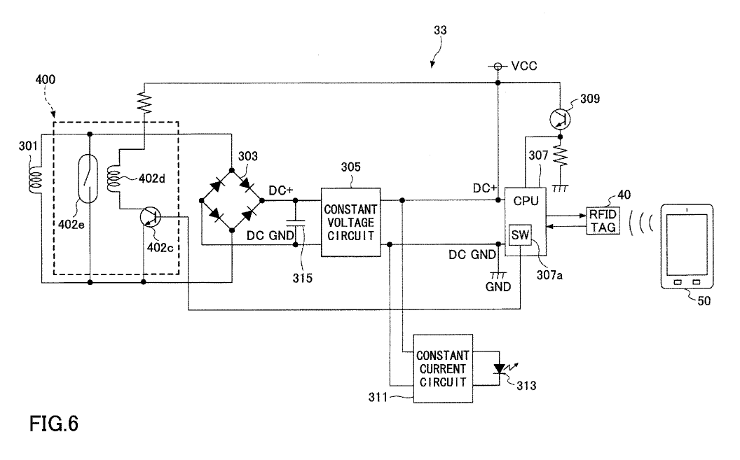

FIG. 6 shows a first modified example of the light lighting circuit 33 according to an embodiment. In the locking mechanism according to the first modified example, only the configuration in the generator short circuit 400 is different from and other configuration is the same as that described above. Therefore, herein, only the generator short circuit 400 according to the first modified example is described, and the description of the other elements are omitted.

As shown in FIG. 6, the generator short circuit 400 according to the first modified example does not includes the photo coupler 402 (including the light-emitting diode 402a and the photo triac 402b) and the triac 401, and includes a transistor 402c, a coil 402d and a lead switch 402e. The lead switch 402e includes two ferromagnetic leads that face each other with a certain contacting distance and are sealed in a glass tube.

Here, nitrogen gas is sealed in the glass tub to prevent the contact point from being activated. When a magnetic field is externally applied to the lead switch 402e in the lead axis direction, the leads are magnetized, so that the free ends of the leads facing each other approach and contact each other to close the circuit. Further, when the magnetic field is removed, the circuit is open due to the elasticity of the leads.

As described above, when determining that the bicycle specific information does not correspond to (is different from) the input key information, the switch 307a of the CPU 307 is set (turned) on and a current flows to the transistor 402c. As a result, the current flows through the coil 402d and a magnetic field is generated. Then, the magnetic field is applied to the lead switch 402e in the lead axis direction.

As a result, the leads are magnetized, so that the free ends of the leads facing each other approach and contact each other to close the circuit, so that the lead switch 402e is set to be in an ON state. By doing this, the it become possible to set the dynamo coil 301 to be in the short-circuit state and lock the bicycle 10.

On the other hand, when determining that the bicycle specific information corresponds to (is the same as) the input key information, the switch 307a of the CPU 307 is set (turned) off and no current flows to the transistor 402c. As a result, no current flows through the coil 402d and a magnetic field is not generated.

Accordingly, the magnetic field is removed and the circuit of the lead switch 402e is open due to the elasticity of the leads. By doing this, the state of the dynamo coil 301 is returned to the normal state from the short-circuit state and the locking of the bicycle 10 is released.

Here, the lead switch 402e and the triac 401 are examples of an AC bi-directional switching device.

### Second Modified Example

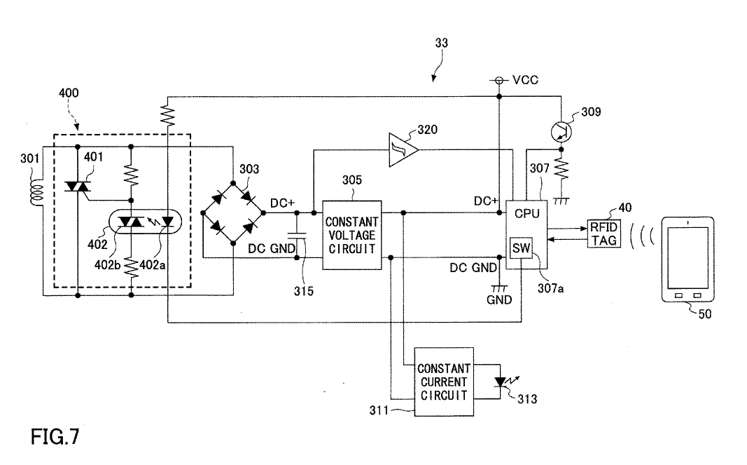

FIG. 7 shows a second modified example of the light lighting circuit 33 according to an embodiment. In the locking mechanism according to the second modified example, a comparator 320 for voltage detection is added to the light lighting circuit of FIG. 3. Therefore, herein, only the function of the comparator 320 is described, and the descriptions of the other elements are omitted.

The comparator 320 in this second modified example has a hysteresis characteristic and functions as an alternating current (AC) detection circuit capable of counting the number of rotations of the generator. The comparator 320 is an example of an AC voltage detection circuit. As another example of the AC voltage detection circuit, there is a zero crossing circuit.

When the voltage of the circuit increases, the CPU 307 is turned on, and then the device of the comparator 320 is turned on, so that the CPU 307 detects the output state of the comparator 320. In a case of detecting the voltage, the CPU 307 turns on the switch 307a and the triac 401. By doing this, a current flows through the triac 401 and the input side and the output side of the dynamo coil 301 are short-circuited, and the bicycle 10 is locked to prevent the bicycle 10 from being operated.

By doing this, when a user attempts to move the bicycle, the bicycle is locked; when the bicycle is stopped, the locking is released; and when the user attempts to move the bicycle again, the bicycle is locked again.

### Operations of Locking System

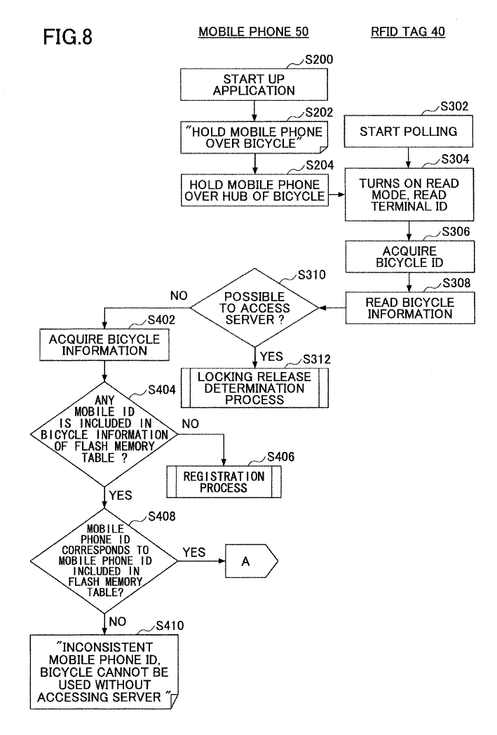

Next, operations of a locking system according to an embodiment are described. First, with reference to FIG. 8, a bicycle locking process according to an embodiment is described. FIG. 8 is a example flowchart of the bicycle locking process according to an embodiment.

### Locking Process

First, the mobile phone 50 starts up a bicycle management application (step S200). To that end, for example, a user of the mobile phone 50 clicks the icon for the bicycle management application displayed on the screen of the mobile phone 50. Then, to use the bicycle management application, the user inputs his/her user ID and password. When the user is authenticated based on the input data, the bicycle management application becomes usable for the user.

When the user is authenticated, a message “please hold this over the bicycle” is displayed on the screen of the mobile phone 50 (step S202). The user holds the mobile phone 50 over the hub of the bicycle whose locking is to be released by the user (step S204).

The REID tag 40 starts polling (step S302). Here, the “polling” herein refers to a method in which when the REID tag 40 operates in collaboration with plural devices including the mobile phone 50, the REID tag 40 sequentially queries the devices one by one if any of the devices has a transmission request.

By the polling, when detecting that the mobile phone 50 is held over the hub of the bicycle 10, the REID tag 40 turns on a read mode, reads a terminal ID of the mobile phone 50 (step S304), acquires a bicycle ID (step S306), and reads bicycle information (step S308). The “bicycle information” herein is stored in, for example, a flash memory table of the REID tag 40.

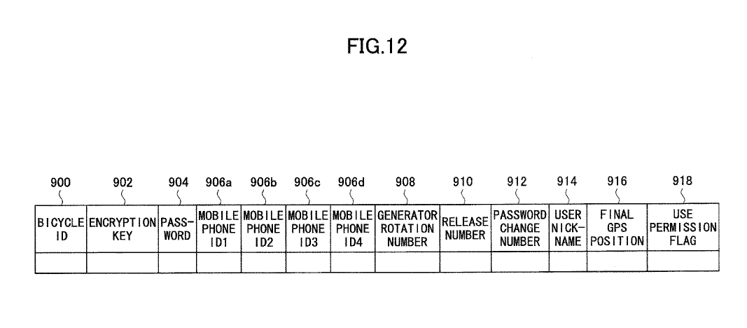

FIG. 12 shows an example of the flash memory table. In FIG. 12, for example, the bicycle information stored in the flash memory table includes the bicycle ID 900, an encryption key 902, a password 904, a mobile phone ID1 906a, a mobile phone ID2 906b, a mobile phone ID3 906c, a mobile phone ID4 906d, a generator rotation number 908 (the number of rotations of the generator), a release number 910 (the number of released times), a password change number 912 (the number of changed times), user nickname 914, a final GPS position 916, and the use permission flag 918.

As the final GPS position 916, the position where the bicycle is locked is stored. Based on the final GPS position 916, it may become possible to specify the place where the bicycle was stolen. Further, for example, when the locking of the bicycle 10 is to be released at the place different from the place where the bicycle 10 is locked, it becomes possible to display a message “someone may have moved the bicycle”.

The user nickname 914 may be displayed when the user releases the locking of the bicycle 10. By doing this, the user may feel comfortable and develop a deep affection for the bicycle 10. The generator rotation number 908 can be used to calculate the travel distance, an average speed and the like.

Further, the bicycle management application may become usable when the power of the mobile phone 50 is turned on. The mobile phone 50 may include one or more batteries. In this case, the battery state is displayed when the mobile phone 50 is held over the hub of the bicycle 10 for the authentication. By doing this, it becomes possible to estimate the battery service time.

For example, when a rotation switch is turned on, the bicycle management application starts up. However, if the mobile phone 50 is not held or if the authentication using the mobile phone 50 has failed, the rotation switch cannot be operated. In this case, an alarm using LED is displayed indicating that the authentication is not successfully completed. As the use permission flag 918, the value “1” indicating that it is possible to release locking in a case where the bicycle specific information corresponds to (is the same as) the input key information. Otherwise, a default value other than “1” is set.

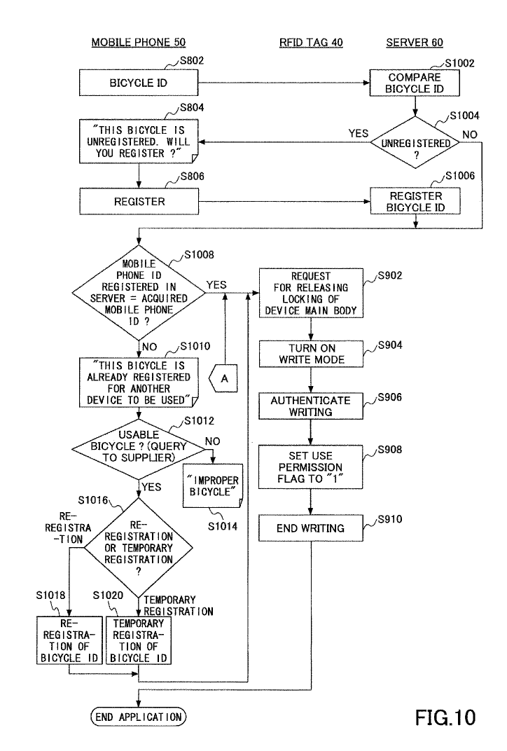

The application that starts up in the mobile phone 50 (hereinafter simplified as “mobile phone 50”) determines whether the mobile phone 50 can be connected to the server 60 (step S310). When determining that the mobile phone 50 can be connected to the server 60, the mobile phone 50 performs a locking release determination process (step S312). Details of the locking release determination process are shown in FIG. 10 and described below.

In step S310, when determining that the mobile phone 50 cannot be connected to the server 60, the mobile phone 50 acquires the bicycle information (step S402). Then, the mobile phone 50 determines whether the ID of the mobile phone 50 is included in the data of the bicycle information stored in the flash memory table (step S404).

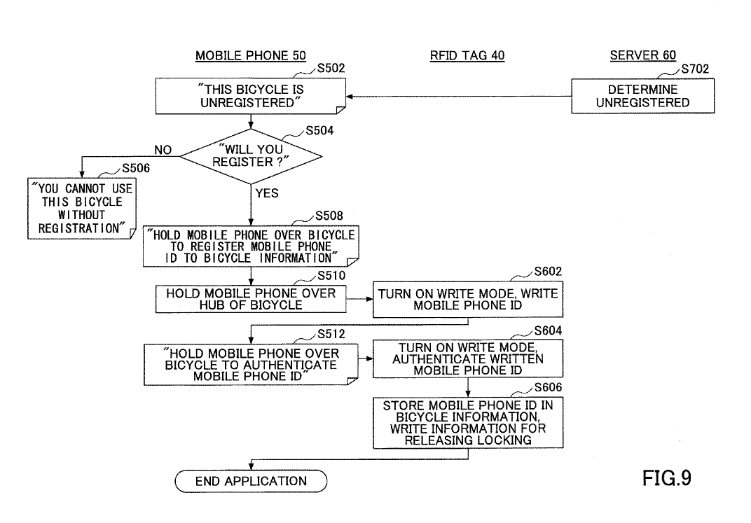

When determining that there is no ID, the mobile phone 50 performs a registration process (step S406). Details of the registration process are shown in FIG. 9 and are described below. In step S404, when determining that there is the ID of the mobile phone 50, the mobile phone 50 further determines whether the mobile phone ID of the mobile phone 50 corresponds to the mobile phone ID in the flash memory table (step S408).

When determining that the mobile phone ID of the mobile phone 50 corresponds to the mobile phone ID in the flash memory table, the process goes to “A” in the locking release determination process of FIG. 10. Otherwise, the mobile phone 50 display an alarm message “inconsistent mobile phone ID, bicycle cannot be used without accessing server” is displayed on the screen (step S410).

### Registration Process

Next, with reference to FIG. 9, details of the registration process (step S406) are described when determining that there is no mobile phone ID in the data of the bicycle information (step S404) in FIG. 8. In the registration process of FIG. 9, first, the server 60 connected with the mobile phone 50 determines whether the bicycle 10 is not registered (step S702).

When determining that the bicycle 10 is not registered, the server 60 reports the determination result to the mobile phone 50, so that the mobile phone 50 displays a message “this bicycle is unregistered” (step S502) and then further displays “will you register ?” (step S504). When no registration is made, a message “this bicycle cannot be used without registration” is displayed (step S506).

On the other hand, when the registration is going to be done, the mobile phone 50 displays a message “please hold the mobile phone over the bicycle for registering the mobile phone ID in bicycle information” (step S508).

When the mobile phone 50 is held over the hub of the bicycle 10 (step S510), the RFID tag 40 turns on a write mode and writes the mobile phone ID (step S602). Next, the mobile phone 50 displays a message “please hold this mobile phone over the bicycle to authenticate the mobile phone ID” (step S512).

The RFID tag 40 turns on the write mode and authenticates the writing of the mobile phone ID (step S604). By doing this, the mobile phone ID is stored in the bicycle information of the flash memory table, and the bicycle specific information as the comparison key information for releasing the locking is written (step S606). Then, the mobile phone 50 completes the registration process.

### Locking Release Determination Process

Next, with reference to FIG. 10, details of the locking release determination process (step S312) are described when it is determined that the mobile phone 50 cannot be connected to the server 60 (step S310) in FIG. 8. In the locking release determination process of FIG. 10, first, while being connected with the server 60, the mobile phone 50 transmits the bicycle ID to the server 60 (step S802). Then, the server 60 authenticates (compares) the bicycle ID (step S1002).

As a result of the comparison, the server 60 determines whether the bicycle ID is unregistered (step S1004). When determining that the bicycle ID is unregistered, the server 60 transmits the comparison result to the mobile phone 50. The mobile phone 50 displays a message “this bicycle is unregistered, will you register ?” (step S804).

Further, when a new battery is connected to the bicycle and the power of a device such as the mobile phone 50 is turned on, before the new battery can be used, if the mobile phone 50 is held over the bicycle, the mobile phone 50 detects that the battery is new and is not authenticated.

Therefore, a message whether to register the battery is displayed. In this case, the main body of the mobile phone 50 may blink the LED light to give notice of the unauthenticated state. When registered, both the IDs of the main body and the battery of the mobile phone 50 are registered in both the main body and the battery. Further, the IDs of the main body and the battery of the mobile phone 50 are registered in the supplier (manufacturer) via the mobile phone 50.

On the other hand, when the bicycle is registered (step S806), the mobile phone 50 gives notice of the registration to the server 60. In response to the notice, the server 60 registers the bicycle ID (step S1006). As described above, when the registration of the bicycle ID is completed (step S1004) or the bicycle ID is registered (step S1006), the state is notified from the server 60.

The mobile phone 50 determines whether the mobile phone ID registered in the server corresponds to the acquired mobile phone ID (step S1008). When determining that the mobile phone ID registered in the server corresponds to the acquired mobile phone ID, the RFID tag 40 sends a request for releasing the locking of the main body (i.e., the bicycle in this case) (step S902).

The RFID tag 40 turns on the write mode (step S904), authenticates the writing (step S906), sets the value of the use permission flag of the bicycle information in the flash memory table to “1” (step S908), and then, ends the writing (step S910). By doing this, the locking release determination process performed by the mobile phone 50 is terminated.

On the other hand, when determining that the mobile phone ID registered in the server does not correspond to the acquired mobile phone ID in step S1008, the mobile phone 50 displays a message “this bicycle is already registered for another device” (step S1010).

When the bicycle is stolen, or when a battery of another user is connected to the bicycle, the LED indicating an unauthenticated state is turned on when the power is turned on. In response to this state, a user may request for temporary permission or permanent permission.

Namely, when the mobile phone 50 is held over the bicycle, a message indicates that the connected battery is being registered by someone else. In this case, the user may forcibly register the battery or may stop the registration. When the battery is forcibly registered, the battery is registered by the supplier (manufacturer) via the mobile phone 50.

The mobile phone 50 queries the server of the supplier whether the bicycle is usable (step S1012). When the bicycle is not usable, a message “Use of the bicycle is not authorized (improper bicycle)” (step S1014). When the bicycle is usable it is determined whether re-registration or temporary registration is to be done (step S1016).

When it is determined that the re-registration is to be done according to the user's instructions, the re-registration of the bicycle ID is done (step S1018). Then, the process goes to a lock releasing process from step S902. On the other hand, when it is determined that the temporary registration be done according to the user's instructions, the temporary registration of the bicycle ID is performed (step S1020).

Then the process goes to the lock releasing process from step S902 indicated as “A”. The process in steps S902 through S910 is described above. Therefore, the repeated descriptions thereof are herein omitted. Further, in a case where it is determined that the mobile phone ID of the mobile phone 50 corresponds to the mobile phone ID in the flash memory table, the process also goes to the lock releasing process from step S902 indicated as “A”. Operations of locking system: simple mode

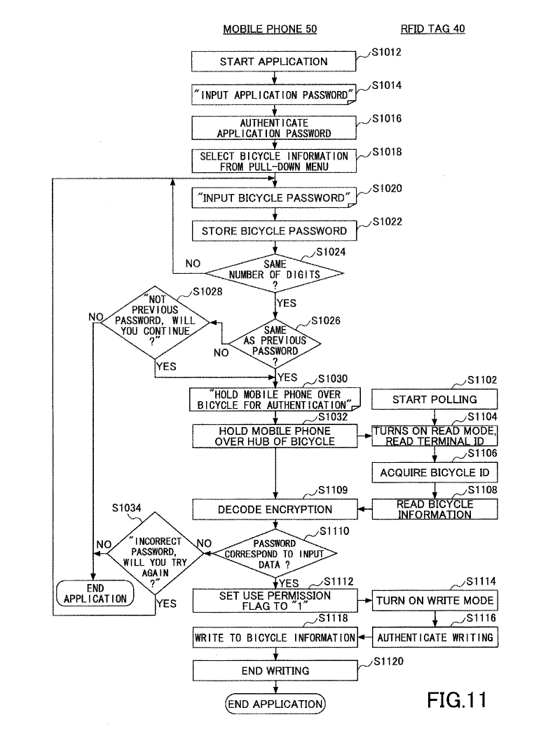

Finally, a simple-mode operation of the locking system according to an embodiment is described with reference to FIG. 11. FIG. 11 is an example flowchart of the locking process (in a simple mode) of the bicycle according to an embodiment.

First, the mobile phone 50 starts up the bicycle management application (in the simple mode) (step S1012). Next, mobile phone 50 displays a message “input application password” (step S1014). The mobile phone 50 recognizes the password input by the user's operation (step S1016).

The mobile phone 50 selects the bicycle information from a pull-down menu (step S1018). Next, the mobile phone 50 displays a message “Input bicycle password” (step S1020). The mobile phone 50 stores the bicycle password input by the user's operation into a memory (step S1022).

Next, the mobile phone 50 determines whether the number of digits of the bicycle password is correct (step S1024). When determining that the number of digits of the bicycle password is not correct, the process of steps S1020 and S1022 is repeated. When determining that number of digits of the bicycle password is correct, the mobile phone 50 determines whether the input bicycle password is the same as the previous bicycle password (step S1026). When determining that the input bicycle password is different from the previous bicycle password, the mobile phone 50 displays a message “different from the previous input password, will you continue ?” (step S1028).

When it is determined that the user will not continue, this application ends. On the other hand, in step S1026, when determining that the input bicycle password is the same as the previous bicycle password or in step S1028 when determining that the user will continue, the mobile phone 50 displays a message “please hold this mobile phone over the bicycle to be authenticated” (step S1030).

When the mobile phone 50 is held over the hub of the bicycle (step S1032), the polling is started (step S1102). The read mode of the RFID tag 40 is turned on (step S1104), and the bicycle ID is acquired from the mobile phone 50 via radio communications (step S1106). The bicycle information of the acquired bicycle ID is read from the bicycle information in the flash memory table (step S1108).

The mobile phone 50 acquires the bicycle information read by the REID tag 40 and deciphers the code using the encryption key (step S1109). As the decoding result, the mobile phone 50 determines whether the password corresponds to the input password information (step S1110).

When determining that the password does not correspond to the input password information, the mobile phone 50 displays a message “Incorrect password, will you try again ?” (step S1034). In case of another try, the process goes back to step S1020. In case of no more try, the process of the bicycle management application is terminated.

In step S1110, when determining that the passwords correspond to each other, the mobile phone 50 sets the value of the use permission flag in the bicycle information of the flash memory table to “1” (step S1112), and then, turns on the write mode of the REID tag 40 (step S1114), and performs writing and authentication by radio communications (step S1118). After the writing is completed (step S1120), the process of the bicycle management application is terminated.

Further, as the key information for lock releasing, for example, the mobile phone ID, password, the bicycle ID, the user's personal identification number and the like may be appropriately used.

As described above, in the locking system according to an embodiment, when the key information from the mobile phone 50 read from the RFID tag 40 corresponds to the previously registered number, the use permission flag is set to “1”. Therefore, the locking of the bicycle is released.

On the other hand, when the key information from the mobile phone 50 read from the RFID tag 40 does not correspond to the previously registered number, the value of the use permission flag is set to a default value other than “1”. Therefore, the switch 307a of the CPU 307 is switched on; the generator short circuit 400 is set to be in a conducting state; and the dynamo coil 301 is in a short-circuit state.

By doing this, even as a user pedals the bicycle, the state is in the locking state where no desired current is supplied in the power line, so that it becomes impossible to run the bicycle 10.

According to an embodiment of the present invention, it may become possible to provide a locking mechanism and a locking system for locking a device that acquires power from the generator by short-circuiting the generator.

Although the preferred embodiments of the locking mechanism and the locking system are described with reference to the accompanying drawings, the present invention is not limited to the examples of the technical scopes of the described locking mechanism and the locking system. Namely, it is obvious that one skilled in the art would easily occur modifications and alternative constructions without departing the technical scopes of the present invention. Therefore, it should be noted that such modifications and alternative constructions belong to the technical scopes of the locking mechanism and the locking system according to present invention. Further, when there are plural modifications and alternative constructions, any combination thereof may also be achieved without departing from the technical scopes of the present invention.

What is claimed is:

1. A locking mechanism attached to a device acquiring power from a power generator mounted on the device, the locking mechanism comprising:
a radio tag configured to acquire key information, which is for releasing locking, by radio communications;
a short-circuit unit configured to short-circuit the power generator; and
a control unit configured to acquire specific information of the device, make comparison between the specific information and the key information acquired by the radio tag, and cause the short-circuit unit to short-circuit the power generator based on a result of the comparison, so as to control locking of the device.

2. The locking mechanism according to claim 1,
wherein a power to drive the short-circuit unit is supplied based on the power generated by the power generator.

3. The locking mechanism according to claim 1,
wherein when the result of the comparison shows that the specific information differs from the key information acquired by the radio tag, the control unit is configured to set the short-circuit unit to be in a conducting state so as to short-circuit the power generator.

4. The locking mechanism according to claim 1, further comprising:
a rectifier circuit configured to rectify an alternating voltage supplied from the power generator;
a stabilizing circuit configured to stabilize a voltage output from the rectifier circuit; and
a light lighting circuit configured to turn on a light based on a voltage supplied from the power generator via the rectifier circuit and the stabilizing circuit,
wherein the short-circuit unit is connected between the power generator and the rectifier circuit.

5. The locking mechanism according to claim 4,
wherein the control unit is configured to be driven by the voltage supplied from the power generator via the rectifier circuit and the stabilizing circuit.

6. The locking mechanism according to claim 1,
wherein the control unit is configured to set an AC bi-directional switching device of the short-circuit unit to be in a conducting state by using the voltage supplied from the power generator, so as to short circuit the power generator.

7. The locking mechanism according to claim 4,
wherein the light lighting circuit includes an AC detection circuit that counts a number of rotations of the power generator.

8. A locking system that manages locking of a bicycle by using an electronic device wirelessly communicative with the locking system, the bicycle acquiring power from a power generator mounted on the bicycle,
wherein the electronic device is configured to transmit key information which is for releasing the locking,
wherein the bicycle includes
a radio tag configured to acquire the key information transmitted from the electronic device by radio communications;
a short-circuit unit configured to short-circuit the power generator; and
a control unit configured to acquire specific information of the bicycle, make comparison between the specific information and the key information acquired by the radio tag, and cause the short-circuit unit to short-circuit the power generator based on a result of the comparison, so as to control locking of the bicycle.

9. The locking system according to claim 8,
wherein the radio tag is configured to transmit the acquired key information and the specific information of the bicycle to a server and acquire the result of the comparison from the server,
wherein the power generator is configured to generates power in accordance with the rotation of tires or pedals of the bicycle, and
wherein the control unit is configured to, when the specific information is different from the acquired key information as the result of the comparison acquired from the server, supply a voltage, which is supplied based on the power from the power generator, to the short-circuit unit as a driving voltage, so as to set the short-circuit unit to be in a conducting state to short-circuit the power generator.

10. A locking mechanism attached to a device acquiring power from a power generator mounted on the device, the locking mechanism comprising:
a short-circuit unit configured to short-circuit the power generator; and
a control unit configured to, when determining that the device is to be locked based on externally acquired key information, control the short-circuit unit so as to short-circuit the power generator.
